(19) United States
(12) Patent Application Publication
(10) Pub. No.: US 2004/0202088 A1
(43) Pub. Date: Oct. 14, 2004

(54) Polarizing optical element, diffractive optical element, optical element unit, optical pickup apparatus, and optical disk drive apparatus

(76) Inventor: Shigeru Oohchida, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/743,030

(22) Filed: Dec. 23, 2003

(30) Foreign Application Priority Data
Dec. 27, 2002 (JP) 2002-380778

(51) Int. Cl. G11B 7/135

(52) U.S. Cl. 369/112.16; 369/112.05; 369/112.02

(57) ABSTRACT

A polarizing optical element is used in an optical pickup apparatus. A diffraction grating (hologram) is formed on the polarizing optical element. The diffraction efficiency of the diffraction grating varies in accordance with the polarization direction of an incident optical beam. When the duty ratio of the diffraction grating is defined as the ratio of the width of a protrusion of the diffraction grating to the grating period, the duty ratio of the diffraction grating is within the range of 0.4-0.5.

### BACKGROUND OF THE INVENTION

1. Field of the Invention

The present invention relates to polarizing optical elements, diffractive optical elements, optical element units, optical pickup apparatuses using the above-mentioned elements and units, and optical disk drive apparatuses mounting the optical pickup apparatuses.

2. Description of the Related Art

Optical pickup apparatuses are known that are mounted on optical disk drive apparatuses, for example, and perform recording and reproducing of information with respect to recording media such as optical disks. Recently and continuing, in order to reduce the size and cost of an optical pickup apparatus, a diffractive optical element (holographic element) is used as means for efficiently directing a reflected light including an information signal from a recording medium to a photodetector without returning the reflected light to a light source. Thereby, the reflected light from the recording medium is diffracted by the diffractive optical element (holographic element) and diverged from an exiting beam of the light source.

Various proposals have been made regarding diffractive optical elements (holographic elements) used in optical pickup apparatuses and the manufacturing methods thereof. Japanese Laid-Open Patent Application No. 2002-258725, for example, aiming at providing a holographic element manufacturing method for manufacturing a desired holographic element with a high degree of accuracy and without reducing mass producability, describes that “a holographic element is manufactured such that the diffraction efficiency in +1 order and the luminous exposure become respective predetermined values by, when forming a diffraction grating in each region of a hologram of a holographic element by a photolithography method, measuring the diffraction efficiency in +1 order of the diffraction grating of each region, calculating the duty ratio of each diffraction grating, and determining the luminous exposure based on the duty ratio”.

Japanese Laid-Open Patent Application No. 2002-258725 discloses a hologram processing method in which the diffraction efficiency ratio is maintained at a constant value while confirming the duty ratio of a hologram. The hologram in an optical pickup apparatus is divided into a plurality of regions. If the diffraction efficiencies are different among the regions, offset occurs in a signal (specifically, the balance characteristic in a tracking signal is lost). Accordingly, the diffraction efficiency of each region of the hologram must be identical. In a case where the diffraction efficiency of each region is ideally and exactly identical, the diffraction efficiency is 1.0. However, the diffraction efficiencies vary in the respective regions due to reasons caused in manufacturing. Thus, the diffraction efficiency of each region is controlled within the range of 0.9-1.1. In order to control the diffraction efficiency to fall within the range, the duty ratio is set to 0.4-0.6.

Incidentally, a hologram having a polarizing property transmits a light from a laser light source at high efficiency (approximately 97%), and diffracts a reflected light from an optical disk at high efficiency (approximately 38%). Thus, such a hologram is an important optical element for increasing the recording and/or reproducing speed of an optical disk drive apparatus. On the other hand, the groove of the hologram must be processed deeply so as to make the diffraction highly efficient. However, a hologram having a deep groove and a narrow pitch (grating period) exhibits characteristics of a volume hologram. The characteristics of a volume hologram, which become issues in using the hologram in the optical pickup apparatus, include angular dependency by which the diffraction efficiency is varied in accordance with the incident angle. In an optical pickup apparatus, if a hologram is arranged between a light source and a coupling lens, a converged light enters the hologram. Thus, the incident angle of the light is different between the center portion and the peripheral portion of the light flux. Accordingly, since the diffraction efficiency is varied in the volume hologram, offset occurs in a signal. Therefore, the inventor of the present invention proposes to make the groove shallow so as to minimize the offset.

The present invention is for maintaining the diffraction efficiency of a diffractive optical element at a constant value irrespective of the incident angle of an optical beam. FIG. 1A shows the relationship between the groove depth of a grating and the diffraction efficiency when holograms having different pitches (grating periods) are formed on BK7 glass. FIG. 1B is the side view of the hologram. In the case where the pitch (grating period) is varied from 1.6 to 2.0 μm, if the groove depth is varied for each pitch, though each pitch has a different maximum diffraction efficiency, the diffraction efficiency is maximized to about 40% with the groove depth in the neighborhood of 0.6-0.65 μm.

Assuming that the pitch is 1.6 μm and the groove depth is 0.65 μm, a Q value that represents the volume property of the hologram is obtained by the following equation.

Q=2πλT/n0Λ²

λ=wavelength (660 nm)

T=grating groove depth

n0=refractive index (1.25 (the average value of 1.5 and 1.0)

Λ=grating pitch

The value obtained by the above equation is 0.84. In this case, since the Q value is equal to or less than 1, the hologram can be handled as a plane hologram. Thus, an approximately constant diffraction efficiency can be obtained irrespective of the incident angle of an optical beam.

FIG. 2A shows the relationship between the groove depth of the grating and the diffraction efficiency when polarization holograms having different pitches (grating periods) are formed by using liquid crystal. FIG. 2B is a side view of the hologram. In the case where the pitch is varied from 1.6 to 2.0 μm, when the groove depth is varied, though each pitch has a different maximum diffraction efficiency, the diffraction efficiency is maximized with the groove depth in the neighborhood of 1.7-1.8 μm. Assuming that the pitch is 1.6 μm and the groove depth is 1.8 μm, the Q value that represents the volume property of the hologram is obtained by the following equation.

Q=2πλT/n0Λ²

λ=wavelength (660 nm)

T=grating groove depth

n0=refractive index (1.6 (the average value of 1.7 and 1.5)

Λ=grating pitch

The value obtained by the above equation is 1.82. In this case, since the Q value is greater than or equal to 1, the hologram cannot be handled as a plan hologram, and the characteristics of a volume hologram are exhibited. Here, FIG. 3 shows the dependency of the diffraction efficiency on the incident angle of an optical beam when the Q value of the polarization hologram is varied. If the Q value is greater than or equal to 1 and the characteristics of a volume property are exhibited, as shown in FIG. 3, the diffraction efficiency becomes different in accordance with the incident angle α of an optical beam (for details, refer to “Light Wave Electron Optics”, co-authored by Koyama and Nishihara, CORONA PUBLISHING CO., LTD., pages 116-122). As mentioned above, compared to a normal non-polarization hologram, a high diffraction efficiency cannot be obtained in a polarization hologram unless the groove is made deep. Thus, since the groove depth T is increased, the Q value is increased. As a result, the characteristics of a volume hologram are exhibited, and the diffraction efficiency is different depending on the incident angle of an optical beam. When the diffraction efficiency is different in accordance with the incident angle, the balance in the track signal is lost, and offset may be generated.

Further, a case is examined where, in a polarization hologram using liquid crystal, the duty ratio of the grating (the width A of a protrusion of the grating/the pitch Λ) is varied (refer to FIG. 4B. that is a diagram for explaining the duty ratio). FIG. 4A shows variation of the diffraction efficiency in the case where the duty ratio of the grating is varied from 0.1 to 0.9 and the incident angle of an optical beam is varied from −20° to 20° with respect to a grating having the depth at which the maximum diffraction efficiency can be obtained when the light having the wavelength of 403 nm is made incident vertically. When the duty ratio of the grating is small, such as 0.1-0.3, dependency on the incident angle is exhibited, and it is determined that the diffraction efficiency varies in accordance with the incident angle of an optical beam. As mentioned above, it is gradually recognized that, in a polarization hologram, the angular dependency of the diffraction efficiency becomes noticeable in the case where the duty ratio is small as well as the case where the groove depth T value and the Q value are great.

### SUMMARY OF THE INVENTION

It is a general object of the present invention to provide a polarizing optical element, a diffractive optical element, an optical element unit, an optical pickup apparatus using the above-mentioned elements and unit, and an optical disk drive apparatus having the optical pickup apparatus in which one or more of the above-mentioned problems are eliminated.

It is another and more specific object of the present invention to provide a method for controlling the characteristics of a volume hologram exhibited in a polarization hologram, i.e., the dependency on the incident angle of the diffraction efficiency.

It is still another object of the present invention to provide a polarizing optical element and a diffractive optical element in each of which the diffraction efficiency becomes a constant value even if the incident angle of a optical beam is different, by limiting the duty of the grating so as to eliminate differences in the diffraction efficiency caused by differences in the incident angle of the optical beam.

It is yet another object of the present invention to provide an optical element unit in which the polarizing optical element or the diffractive optical element is integrally constituted with a light source and a photodetector.

It is a further object of the present invention to provide an optical pickup apparatus using the polarizing optical element or the diffractive optical element, having an approximately constant diffraction efficiency, to be used in the optical system so as to decrease offset in a signal and to improve reliability.

It is a still further object of the present invention to provide an optical disk drive apparatus capable of stably detecting a signal by mounting the optical pickup apparatus.

In order to achieve the above-mentioned objects, according to one aspect of the present invention, there is provided a polarizing optical element used in an optical pickup apparatus,

wherein a diffraction grating (hologram) is formed on said polarizing optical element, and a diffraction efficiency of said diffraction grating is varied in accordance with a polarization direction of an optical beam incident thereon, and

wherein, when a duty ratio of the diffraction grating is defined as a ratio of a width of a protrusion of the diffraction grating to a grating period, the duty ratio of the diffraction grating is within a range of 0.4-0.5.

Accordingly, in the above-mentioned polarizing optical element, since the duty ratio of the grating is set to the range of 0.4-0.5 (more preferably, approximately 0.45), uniform and high diffraction efficiency is achieved irrespective of the incident angle of an optical beam.

Additionally, in the polarizing optical element, the diffraction grating may be manufactured by forming protrusions and recesses on an optical anisotropic material, and filling at least the recesses with an isotropic material. Accordingly, by processing with accuracy the polarizing optical element having the above-mentioned configuration such that the duty ratio of the grating falls within the range of 0.4-0.5, it is possible to achieve a uniform diffraction efficiency irrespective of the incident angle of an optical beam. Also, it is possible to reduce costs.

Additionally, according to another aspect of the present invention, there is provided a diffractive optical element that is used in an optical pickup apparatus, and has a configuration in which the polarizing optical element is sandwiched between a first optical member and a second optical member.

According to the above-mentioned aspect of the present invention, since the polarizing optical element is sandwiched between the two optical members, it is possible to achieve high planarity and stability with respect to heat and humidity. In addition, light enters in the order of: the air→glass→the polarizing optical element. Thus, compared with the case where light directly enters the polarizing optical element from the air, the incident angle at which the light enters the polarizing optical element is decreased. Hence, it is possible to ensure a large allowable value for dependency of the diffraction efficiency on the incident angle.

Additionally, in the above-mentioned diffractive optical element, the first optical member and the second optical member may have different thicknesses.

Accordingly, since the respective thicknesses of the two optical members are different, the polarizing optical element is made distant from the photodetector. In addition, by decreasing the Q value by increasing the pitch of the grating, it is possible to reduce the dependency of the diffraction efficiency on the incident angle.

Additionally, in the diffractive optical element, the first optical member and the second optical member may have different refractive indexes.

Accordingly, since the refractive index of one of the two optical members is greater than that of the other, the incident angle of an optical beam entering the polarizing optical element is further decreased. Hence, it is possible to ensure the allowable value for the dependency on the incident angle.

Additionally, in the diffractive optical element, a diffraction grating may be formed on a surface of one of the first optical member and the second optical member.

Accordingly, a diffractive grating is formed on one of the two optical members of the diffractive optical element. Hence, it is possible to perform signal detection using three optical beams, and perform stable signal detection with respect to optical axis shift.

Additionally, according to another aspect of the present invention, there is provided an optical element unit including:

a unit into which a light source and a photodetector are integrated; and

one of the polarizing optical element and the diffractive optical element,

wherein the unit is integrated with one of the above-mentioned elements.

According to the above-mentioned aspect of the present invention, since the unit into which the light source and the photodetector are integrated is integrated with the polarizing optical element or the diffractive optical element, it is possible to perform stable signal detection with respect to change-over time.

Additionally, according to another aspect of the present invention, there is provided an optical pickup apparatus that converges light from a light source to a recording medium by a converging lens so as to perform recording and/or reproducing thereon, the optical pickup apparatus including:

an optical system including:

a diffractive optical element arranged on a light path so as to diverge a reflected light from the recording medium; and

a photodetector that receives the reflected light,

wherein the diffractive optical element is one of the polarizing optical element and the above-mentioned diffractive optical element.

Additionally, the optical pickup apparatus may use the above-mentioned optical element unit.

Accordingly, the optical pickup apparatus use the polarizing optical element or the diffractive optical element having a uniform diffraction efficiency irrespective of the incident angle of an optical beam. Hence, it is possible to decrease a signal offset and improve reliability of the optical pickup apparatus.

Additionally, according to another aspect of the present invention, there is provided an optical disk drive apparatus that performs recording and/or reproducing of information with respect to a recording medium, the optical disk drive apparatus including the above-mentioned optical pickup apparatus.

According to the above-mentioned aspect of the present invention, it is possible to perform stable signal detection.

Other objects, features and advantages of the present invention will become more apparent from the following detailed description when read in conjunction with the following drawings.

### BRIEF DESCRIPTION OF THE DRAWINGS

FIG. 1A is a graph showing the relationship between the groove depth of a grating and diffraction efficiency in the case where holograms having protrusions and recesses with different pitches are formed on BK7 glass;

FIG. 1B is a cross-sectional view of the hologram formed on the BK7 glass;

FIG. 2A is a graph showing the relationship between diffraction efficiency and the groove depth of a grating in the case where polarization holograms having different pitches are formed by using liquid crystal;

FIG. 2B is a cross-sectional view of the polarization hologram formed on the BK7 glass by using liquid crystal;

FIG. 3 is a graph showing dependency of the diffraction efficiency on the incident angle of an optical beam in the case where the Q value of the polarization hologram is varied;

FIG. 4A is a graph showing measured results of the diffraction efficiency of a +1 order optical beam by using samples of the polarization hologram having duty ratios of 0.1-0.9 while varying the incident angle of the optical beam from −20° to +20°;

FIG. 4B is a schematic diagram for explaining the duty ratio of the grating of the polarization hologram;

FIG. 5 is a schematic cross-sectional view of a polarization hologram that is a polarizing optical element;

FIG. 6 is a schematic diagram for explaining a method for measuring the diffraction efficiency of the +1 order optical beam by varying the incident angle thereof with respect to the polarization hologram shown in FIG. 5;

FIG. 7 is a schematic diagram for explaining the intensity distribution of a diffracted optical beam in the case where a converged optical beam is incident on the polarization hologram;

FIG. 8 is a schematic cross-sectional view of a polarizing optical element according to one embodiment of the present invention;

FIGS. 9A, 9B and 9C are schematic diagrams for explaining a manufacturing method of an organic stretch film;

FIGS. 10A, 10B, 10C and 10D are schematic diagrams for explaining a manufacturing method of a polarizing optical element using liquid crystal;

FIGS. 11A, 11B, 11C and 11D are schematic diagrams for explaining another manufacturing method of a polarizing optical element using liquid crystal;

FIG. 12 is a schematic cross-sectional view of a diffractive optical element according to one embodiment of the present invention;

FIGS. 13A and 13B are schematic diagrams for explaining functions and effects of the diffractive optical element shown in FIG. 12;

FIGS. 14A and 14B are schematic diagrams for explaining the configuration of an optical element unit into which the diffractive optical element shown in FIG. 9 is integrated;

FIG. 15 is a schematic diagram for explaining the configuration of an optical element unit using a diffractive optical element having a grating on a surface of an optical member;

FIG. 16 is a schematic diagram of an optical pickup apparatus according to one embodiment of the present invention;

FIG. 17 is an outside perspective view of a notebook personal computer and an optical disk drive apparatus mounted thereon; and

FIG. 18 is a block diagram showing a general configuration of the optical disk apparatus.

### DETAILED DESCRIPTION OF THE PREFERRED EMBODIMENTS

A detailed description is given below of embodiments of the present invention, with reference to the drawings illustrating the embodiments.

(Embodiment 1)

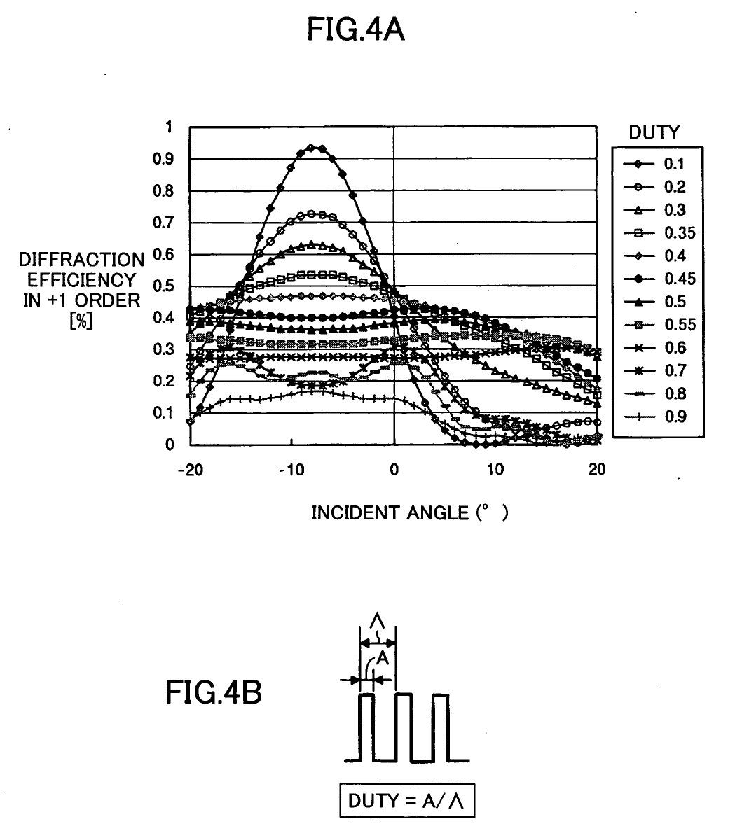

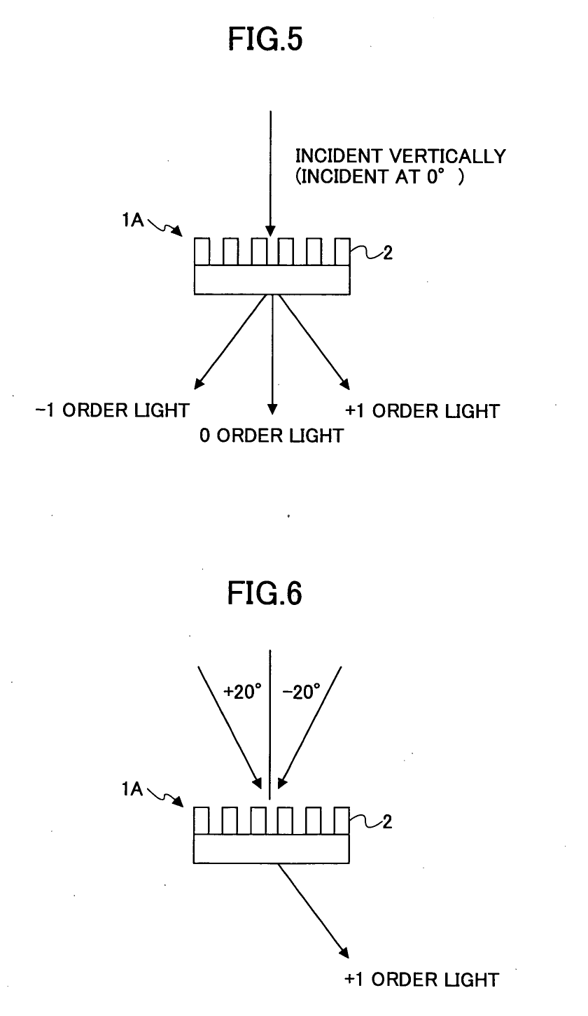

First, referring to FIGS. 5 through 8, a description is given of a first embodiment of the present invention. FIG. 5 is a schematic cross-sectional view of a polarization hologram 1A, which is an example of a polarizing optical element. In the polarization hologram 1A, diffraction gratings (hologram) having protrusions and recesses are formed on an optical anisotropic material (referred to as a birefringent material) 2 having a birefringent property. As shown in FIG. 5, when a optical beam having a wavelength λ (403 nm) is vertically incident (incident at 0°) on the polarization hologram 1A, a transmitted light (0 order light) and diffracted optical beams (here, only ±1 order lights are shown) are generated. It is assumed that the pitch (grating period) of the polarization hologram 1A is 1 μm, and the groove has the depth at which the diffraction efficiency is maximized at the time when a optical beam having the wavelength of 403 nm is vertically incident on the polarization hologram 1A. Samples of the polarization hologram 1A with the above-assumed configuration are prepared by varying the duty ratio of the grating from 0.1 to 0.9. Then, the diffraction efficiency of the +1 order optical beam is measured by making an optical beam incident on the polarization hologram 1A while varying the incident angle as shown in FIG. 6. FIG. 4A shows the measured results of the diffraction efficiency of the +1 order optical beam in the respective samples having the duty ratios 0.1-0.9.

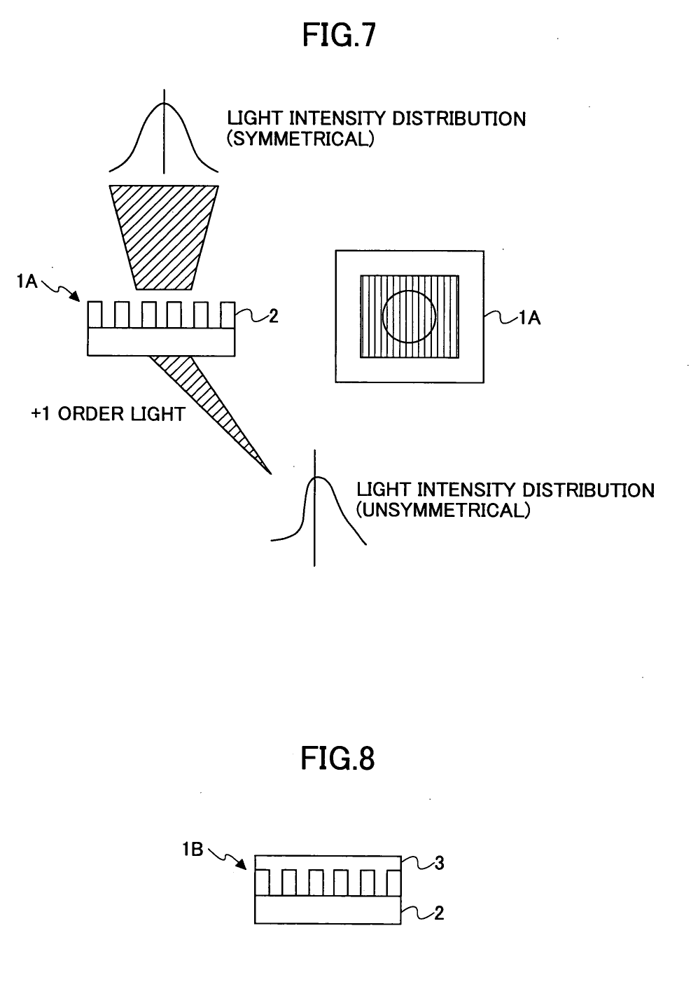

It is preferable for the diffraction efficiency to be high and constant irrespective of the incident angle of an optical beam. As can be seen from FIG. 4A, when the duty ratio of the grating is within the range of 0.1-0.35, the diffraction efficiency is greatly varied in accordance with the incident angle of an optical beam. In the case where the duty ratio is within the range of 0.7-0.9, the diffraction efficiency is varied in accordance with the incident angle, and besides, the values of the diffraction efficiency, per se, are low. When the diffraction efficiency is varied in accordance with the incident angle as in the case where the duty ratio is within the range of 0.1-0.35, if a converged optical beam enters the polarization hologram 1A as shown in FIG. 7, since the diffraction efficiency varies greatly in accordance with the incident angle, the intensity distribution of the diffracted optical beam does not become symmetric. That is, the diffraction efficiency of an optical beam that enters at a positive (+) angle is low, while the diffraction efficiency of an optical beam that enters at a negative (−) angle is high. Thus, the intensity distribution is not symmetric. If such a polarization hologram is used in an optical system of an optical pickup apparatus, the signal is unbalanced, and offset occurs. On the other hand, in the case where the duty ratio is within the range of 0.7-0.9, the diffraction efficiency per se is low. Accordingly, if such a polarization hologram is used in the optical system of the optical pickup apparatus, detected amount of light is small. Thus, such a polarization hologram is not suitable for high-speed recording and reproducing.

Based on the above-mentioned results, it is believed that the preferable range for the duty ratio of the grating is 0.4-0.6. If the duty ratio is within the range of 0.55-0.6, however, the diffraction efficiency is not varied in accordance with the incident angle and good angle characteristics are obtained. On the other hand, the diffraction efficiency is reduced by no less than approximately 10%, compared to the case where the duty ratio is within the range of 0.4-0.5. For this reason, the range of 0.55-0.6 is not preferable for aiming at high-speed recording and reproducing. Accordingly, in terms of achieving low angular dependency and high diffraction efficiency, it is preferable for the duty ratio to be within the range of 0.4-0.5. When the duty ratio is 0.4, the diffraction efficiency exhibits slight angular dependency. When the duty ratio is 0.5, the diffraction efficiency is low. Therefore, it can be said that the optimum duty ratio is 0.45.

When the duty ratio of the grating is within the range of 0.4-0.5, if the incident angle becomes greater than +10°, the diffraction efficiency is reduced. However, in a normal optical pickup apparatus, based on limitations caused by the numerical aperture of a collimate lens and the emission angle of a laser light source, the incident angle at which an optical beam enters a polarization hologram is ±10° in most cases. Thus, practically, there is no problem.

(Embodiment 2)

In Embodiment 1, it is described that the duty ratio suitable for the polarization hologram 1A is within the range of 0.4-0.5. However, conversely, variation in the duty ratio must be controlled within the range of 0.4-0.5.

Several methods are known for manufacturing a polarization hologram. In one of such methods, a polarization hologram is manufactured by proton exchange using LiNbO₃ crystal (refer to Japanese Laid-Open Patent Application No. 6-194523). Regarding a method for proton exchange, a description is given in “Optical Integrated Circuits”, co-authored by Nishihara, Haruna, and Suhara, Ohmsha, Ltd., pages 167-170. Since proton exchange uses the penetration of hydrogen ions into crystal, it is difficult to manufacture a polarization hologram with a rectangular shape and with a good degree of accuracy. Accordingly, in order to manufacture a polarization hologram while controlling the duty ratio of the grating to fall within the range of 0.4-0.5, it is preferable to process the groove mechanically or chemically. To be more specific, as shown in FIG. 8, for a polarization hologram 1B, it is suitable to apply a method of forming a grating having protrusions and recesses on the optical anisotropic material (birefringent material) 2 by etching, and filling in at least the recesses with an isotropic material 3 having a refractive index the same as one of the refractive indexes no and ne of the optical anisotropic material 2 (refer to Japanese Patent Gazette No. 2594548).

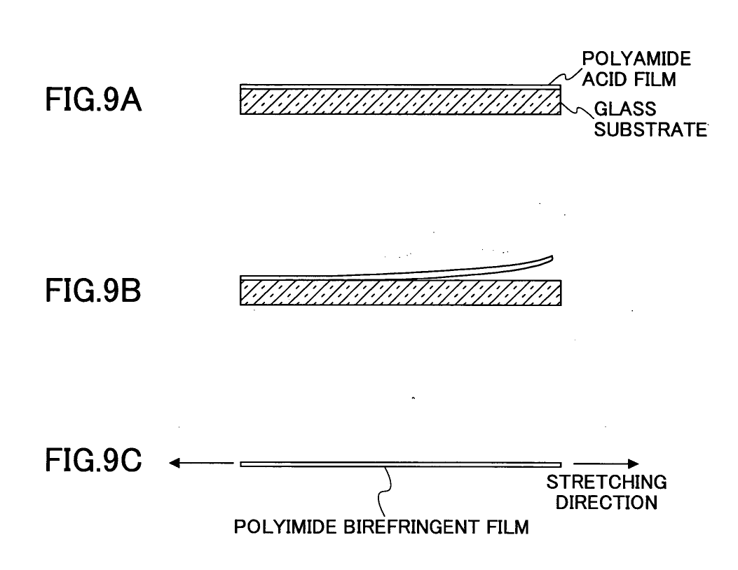

This embodiment proposes to use an organic stretch film as the optical anisotropic material 2 in the polarization hologram 1B having the configuration as shown in FIG. 8. In Japanese Patent Gazette No. 2594548, calcite is shown as an optical anisotropic material. Compared to calcite, an organic stretch film is advantageous in that the thickness is less, the price is moderate, and the area can be increased easily. In order to process the material such that the duty ratio of the grating falls within the range of 0.4-0.5, a mask should be formed in photolithography processing such that the duty ratio falls within the range of 0.4-0.5. As a specific method for manufacturing the organic stretch film, there is a method of orienting molecular chains in a uniaxial direction by stretching a polymer membrane of polyimide, polycarbonate, and polyethylene terephthalate, for example, so as to generate birefringence in the surface. FIGS. 9A, 9B and 9C show a method of manufacturing an organic stretch film. In this method, a polyamide acid film is formed on a glass substrate. Then, as shown in FIG. 9B, the polyamide acid film is removed from the glass substrate. Thereafter, as shown in FIG. 9C, the molecular chain is oriented in a uniaxial direction by stretching, thereby manufacturing a polyimide birefringent film. With this method, it is possible to vary the birefringence Δn by varying the temperature and the force to be applied at the time of stretching. Thus, according to the method, it is possible to manufacture an organic stretch film at low cost and in large quantity. It should be noted that the applicant of the present invention has already proposed to use an organic stretch film for a hologram (refer to Japanese Laid-Open Patent Application No. 2000-75130).

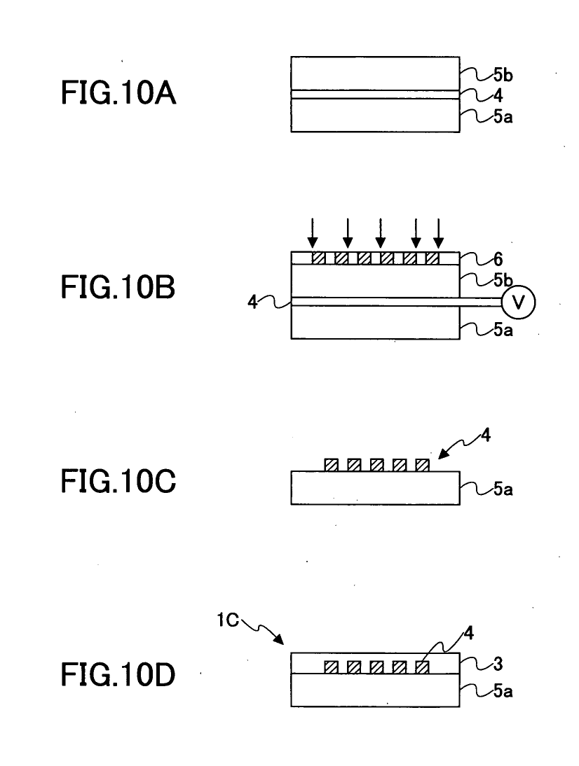

Further, other than an organic stretch film, it is also possible to use a liquid crystal as the material. The orientation direction of liquid crystal is varied depending on whether a voltage is applied thereto. The difference in the orientation direction results in a difference in the refractive index. FIGS. 10A, 10B, 10C and 10D show a manufacturing process flow of a polarization hologram using liquid crystal. As shown in FIG. 10A, liquid crystal 4 is provided between two substrates 5a and 5b. Then, as shown in FIG. 10B, electrodes are provided on both surfaces of the liquid crystal 4 and a voltage is applied, so that the liquid crystal 4 takes an oriented state. In this state, exposure is performed via a mask 6 having a grating pattern, and the liquid crystal 4 is cured. Then, as shown in FIG. 10C, leaving only cured portions of the liquid crystal 4, the other portions are removed together with the upper substrate 5b. As shown in FIG. 10D, a polarization hologram 1C is formed by filling the recesses with the isotropic material 3 having a refractive index the same as one of the refractive indexes no and ne of the liquid crystal 4. In the above-mentioned process flow, since an etching process is not required, the process flow is simplified. In addition, since an expensive etching apparatus is not required, equipment investment is low. Thus, the cost can also be reduced.

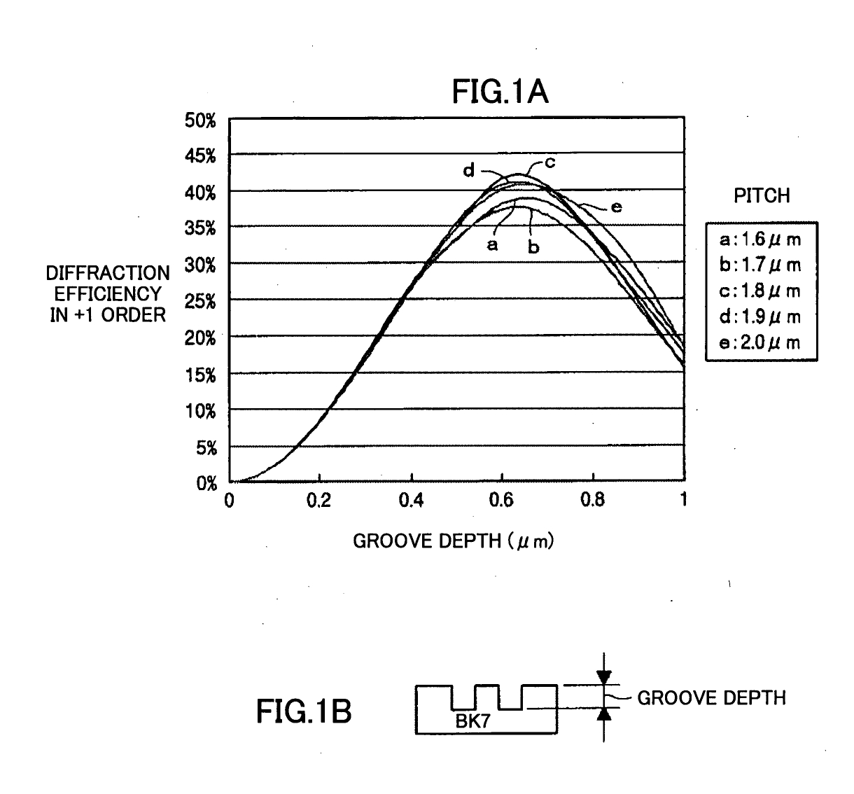

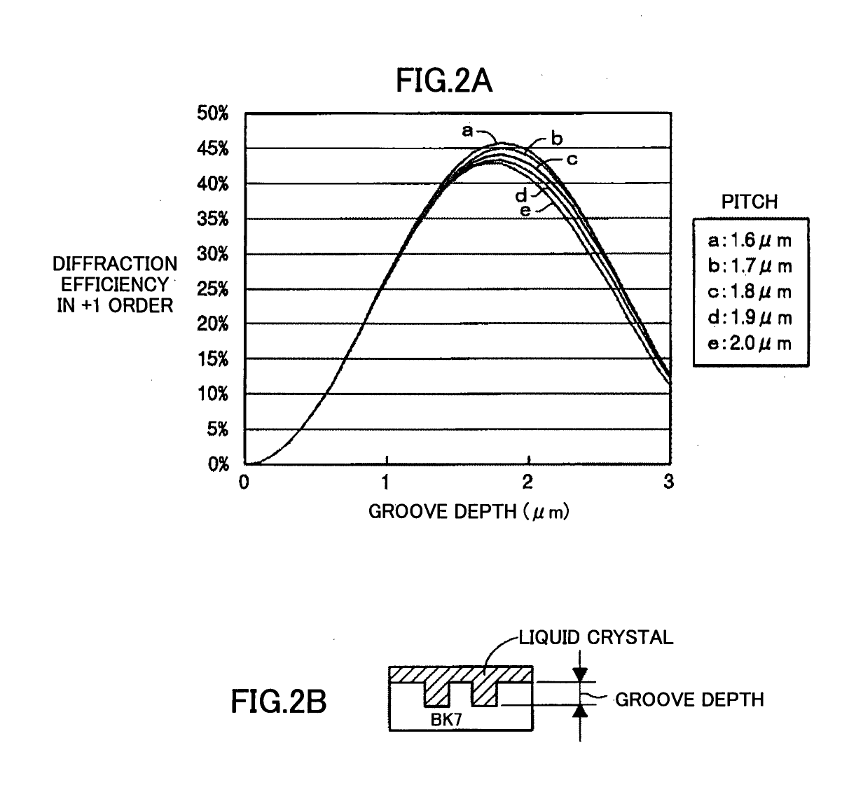

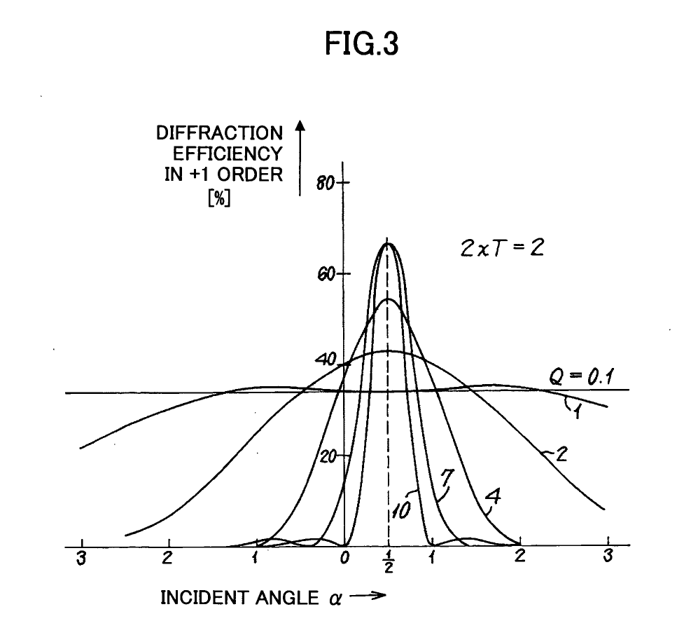

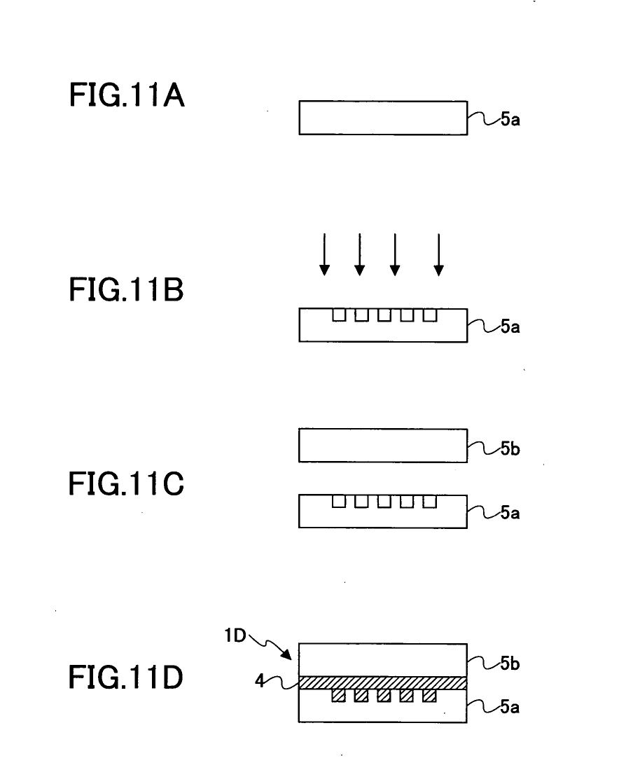

Further, as shown in FIGS. 11A, 11B, 11C and 1D, there is another method of manufacturing a polarization hologram by using liquid crystal. First, as shown in FIGS. 11A and 11B, a photolithography process and an etching process are performed on the isotropic substrate 5a so that protrusions and recesses are formed thereon. Then, as shown in FIG. 1C, the substrate 5b is laminated onto the isotropic substrate 5a. As shown in FIG. 11D, the space between the substrates 5a and 5b is filled with the liquid crystal 4, thereby forming a polarization hologram 1D. Such a method is disclosed in Japanese Laid-Open Patent Application No. 9-102138, for example. In this method, a glass substrate and the like are etched. Thus, the method is advantageous in that the process can be performed easily while controlling the duty ratio to fall within the range of 0.4-0.5.

(Embodiment 3)

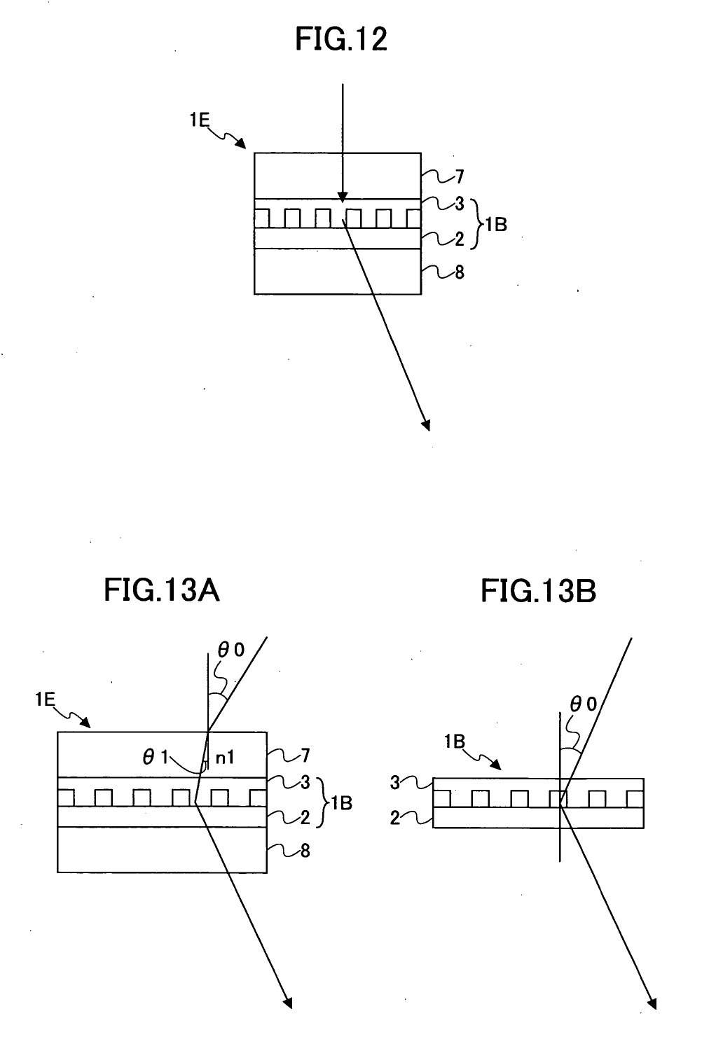

A description is next given of a diffractive optical element having a configuration in which the polarizing optical element (polarization hologram) described in Embodiments 1 and 2 is sandwiched between two optical members (transparent planar substrates, for example). FIG. 12 shows such a configuration. In FIG. 12, a diffractive optical element (polarization hologram element) 1E is configured such that the polarizing optical element (polarization hologram) 1B, which is shown in FIG. 8, is sandwiched between a first optical member 7 and a second optical member 8. With such a configuration, since the polarizing optical element 1B is covered by the optical members (specifically, transparent planar substrates formed by glass or plastic members) 7 and 8, planarity is high and stability is achieved with respect to heat and humidity. In addition, since the hologram surface is not directly exposed, the polarization hologram is not scratched or made dirty. In this manner, with the configuration in which the optical members 7 and 8 cover the polarizing optical element 1B, even if the surfaces of the optical members 7 and 8 become dirty, it is possible to wipe off contamination.

Further, when the polarization optical member 1B is covered by the optical members 7 and 8, as shown in FIG. 13A, an optical beam enters in the following order: the air→the optical member 7→the polarizing optical element 1B. Thus, compared with the case where an optical beam directly enters the polarizing optical element 1B from the air, as shown in FIG. 13B, the incident angle at which the optical beam enters the polarizing optical member 1B is decreased. Additionally, when the incident angle of the optical beam is θ0, as shown in FIG. 13B, without an optical member, the optical beam enters the polarizing optical element 1B at the incident angle θ0. On the other hand, with the optical member 7 as shown in FIG. 13A, according to Snell's Law,

sin θ0=n1·sin θ1

is established. Thus, the optical beam enters the polarizing optical element 1B at the incident angle θ1. Assuming that θ0=10° and the refractive index n1 of the optical member 7 is n1=1.5, then θ1=6.65°. Accordingly, it is determined that, with the optical member 7, the incident angle with respect to the polarizing optical element 1B is decreased. As shown in FIG. 4A, the diffraction efficiency is varied in accordance with the incident angle. Thus, if the range of the angle of an incident optical beam is narrow, it is possible to increase the range of the available duty ratio, which results in increasing the allowable value of variation caused during the manufacturing process, and improving the yield ratio.

(Embodiment 4)

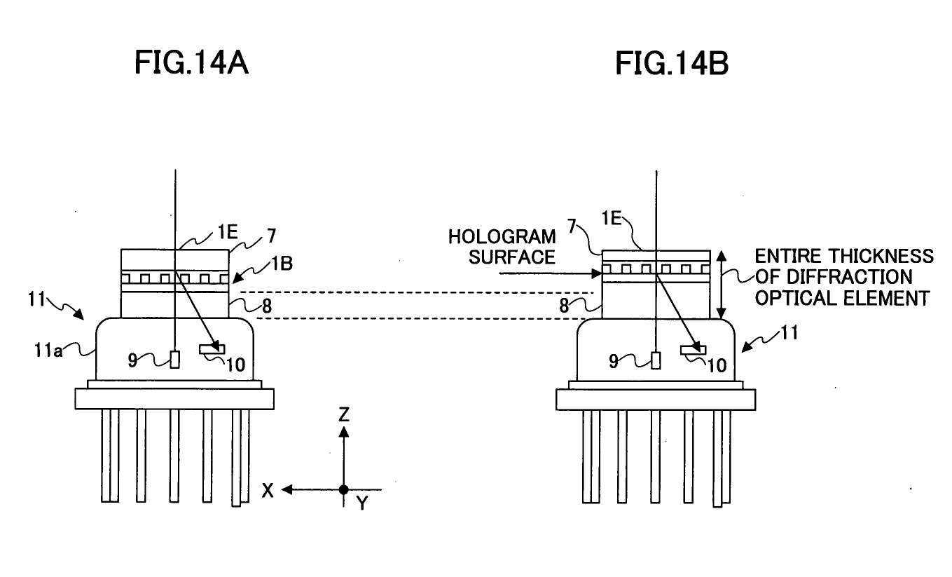

A description is given next of the relationship between the first optical member 7 and the second optical member 8 in a case where the diffractive optical element, which is described in Embodiment 3, is integrated into an optical element unit. FIGS. 14A and 14B each shows a configuration in which the diffractive optical element 1E according to the present invention is mounted on an optical element unit 11. As shown in FIG. 14A, the optical element unit 11 is a hologram light source unit having a configuration in which the diffractive optical element (polarization hologram element) 1E described in Embodiment 3 is fixed to an opening for emitting and receiving an optical beam (hereinafter referred to as a “light emitting and receiving opening”) of a unit 11a that integrally houses a light source 9 consisting of a semiconductor laser, and a photodetector (light-receiving element) 10.

Here, the grating pitch of the polarization hologram 1B of the diffractive optical element 1E is determined by the interval between the hologram surface and the light-receiving element surface of the photodetector 10. It is preferable for the grating pitch of the polarization hologram 1B to be as wide as possible since in that case, the process becomes easy and the Q value is increased. In order to increase the grating pitch of the polarization hologram 1B, the hologram surface and the light-receiving surface of the photodetector 10 should be distant in the optical axis direction (the Z axis direction in FIG. 14A). Accordingly, as shown in FIG. 14B, by increasing the thickness of the second optical member 8, it is possible to make the hologram surface distant from the light-receiving surface of the photodetector 10.

However, if the thickness of the first optical member 7 is increased in proportion to the increased thickness of the second optical member 8, the entire diffractive optical element 1E becomes thick. As a result, cutting becomes difficult in dicing. In dicing, cutting is performed by rotating a blade called a dicer. Thus, when cutting something thick, the cutting speed must be slowed, which results in a long process time. Accordingly, productivity is decreased. Considering dicing, the thickness of the entire diffractive optical element must be, at the most, approximately 3.5 mm or less. Therefore, as shown in FIG. 14B, preferably, when the thickness of the second optical member 8 is increased, the thickness of the first optical member 7 should be decreased just as much.

In this manner, by increasing the thickness of the second optical member 8, it is possible to increase the grating pitch of the polarization hologram 1B. Thus, it becomes easy to manufacture the polarization hologram 1B. Also, since the thickness of the first optical member 7 is decreased, it is possible to prevent the entire thickness of the diffractive optical element 1E from being increased. Thus, the time interval required for the dicing process is not lengthened. Therefore, it is possible to avoid a reduction in productivity.

(Embodiment 5)

A further description is given next of the relationship between the first optical member 7 and the second optical member 8 of the diffractive optical element 1E of the optical element unit 11, which is described in Embodiment 4. As mentioned in Embodiment 3, the refractive index n1 of the first optical member 7 has the relation:

sin θ0=n1·sin θ1.

Accordingly, the greater the refractive index n1 is, the smaller the incident angle θ1 is with respect to the polarization hologram 1B, which has an effect on reducing the influence of angular dependency. Therefore, preferably, a high refractive index glass having the refractive index of approximately 1.7 should be used for the first optical member 7. On the other hand, regarding the second optical member 8, as mentioned in Embodiment 4, preferably, the thickness of the substrate should be increased. Preferably, an inexpensive material that can be processed easily should be used for the second optical member 8 so that cutting does not become difficult in the dicing process. To be specific, BK7, quartz glass, resin, and the like are preferred. As mentioned above, in terms of reduction of angular dependency and workability of the polarization hologram, it is advantageous to use different optical materials for the first optical member 7 and the second optical member 8.

(Embodiment 6)

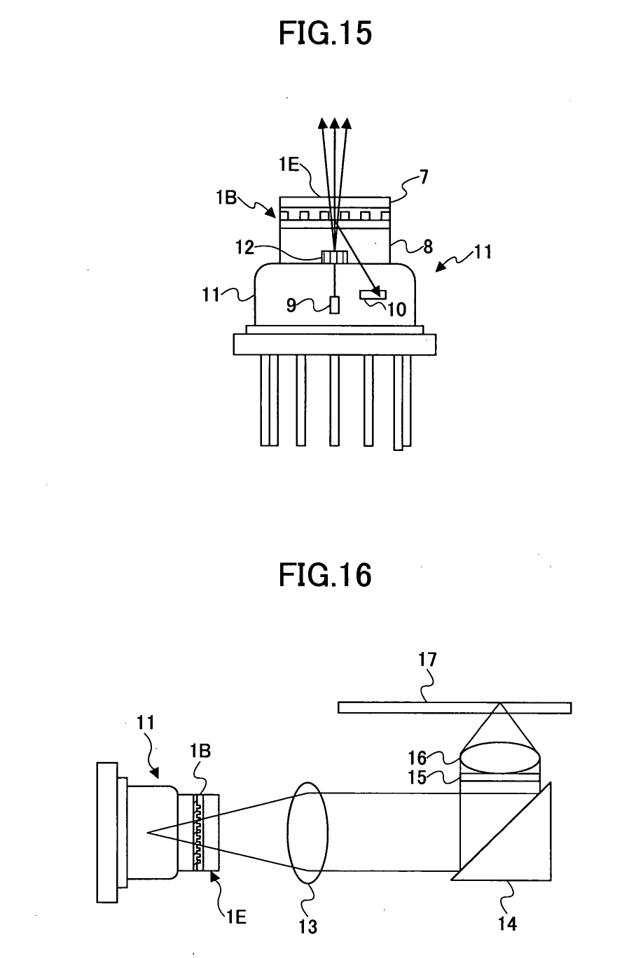

A method is well known in which a track signal is detected by illuminating an optical disk by three optical beams, such as a 3-beam method and a DPP method. By using three optical beams, compared with a method of illuminating using a single beam, influence of track offset is reduced. A diffraction grating is required for generating three optical beams. As shown in FIG. 15, in order to generate three optical beams, it is possible to form a grating 12 on a surface of the second optical member 8. Dividing three optical beams generated by the grating 12 into the main beam (0 order light) and sub-beams (±1 order lights), the main beam (0 order light) is reflected by the optical disk and vertically enters the diffractive optical element 1E. On the other hand, the sub-beams (±1 order lights) enter the diffractive optical element 1E not vertically but at predetermined opposing, i.e., positive and negative, angles. Thus, if the polarizing optical element 1B exhibits angular dependency, a phenomenon is produced in which, among the sub-beams, the diffraction efficiency of the +1 order light is high, while the diffraction efficiency of the −1 order light is low. As a result, it becomes impossible to perform accurate track detection. Accordingly, as in the present invention, the use in an optical pickup apparatus of the polarizing optical element 1B (or the diffractive optical element 1E) configured to reduce angular dependency by limiting the range of the duty ratio from 0.4 to 0.5 serves as effective means for performing accurate signal detection with respect to the method for detecting a track signal by illuminating an optical disk with three optical beams, such as the 3-beam method and the DPP method.

(Embodiment 7)

A description is given next of an embodiment of an optical pickup apparatus. FIG. 16 is a schematic diagram showing an optical pickup apparatus 100 according to one embodiment of the present invention. In FIG. 16, the optical pickup apparatus 100 includes an optical element unit (hologram light source unit) 11, a coupling lens 13, a mirror 14, a ¼ wavelength plate 15, and an objective lens 16 that is a converging lens. Reference numeral 17 denotes an optical disk, which is a recording medium. In the optical element unit 11 of the optical pickup apparatus 100 shown in FIG. 16, as shown in FIGS. 14A and 14B or FIG. 15, the light source 9 and the photodetector (light-receiving element) 10 are integrally provided. The diffractive optical element 1E is integrally placed in the light emitting and receiving opening of the optical element unit 11. It should be noted that the configuration shown in FIG. 16 is an exemplary embodiment and not a limitation for the optical pickup apparatus according to the present invention.

In FIG. 16, linear polarized light emitted from the light source (a semiconductor laser, for example) 9 in the optical element unit 11 is transmitted through the diffractive optical element (polarization hologram element) 1E, and become approximately parallel light via the coupling lens 13. The light path of the parallel light is deflected by the mirror 14 at an approximately right angle. The deflected light becomes circularly polarized light after being transmitted through the ¼ wavelength plate 15. The circularly polarized light is converged by the objective lens 16 and illuminates a recording surface of the optical disk 17 as a minute spot of light. Then, the light that has read a signal on the recording surface of the optical disk 17 is reflected by the recording surface, and becomes circularly polarized light in the direction opposite to that for illuminating the recording surface. The light becomes approximately parallel via the objective lens 16, and becomes linear polarized light, which is orthogonal to the light directed to the objective lens 15 by being transmitted through the ¼ wavelength plate. The light path is then deflected by the mirror 14, and returns to the coupling lens 13. The light is diffracted and diverged by the polarization hologram 1B of the diffractive optical element (polarization hologram element) 1E. The diverged light is received by the photodetector (light-receiving element) 10, thereby detecting signals such as an information signal, a focus error signal, and a tracking error signal.

If the polarizing optical element or the diffractive optical element described in Embodiments 1 through 6 are used in the optical pickup apparatus configured as shown in FIG. 16, the following advantages are achieved.

(1) Since the diffraction efficiency is uniform irrespective of the incident angle, the signal output is not unbalanced. Thus, it is possible to detect an accurate tracking error signal.

(2) The diffraction efficiency is uniform and the diffraction efficiency per se is high. Thus, it is possible to correspond to high-speed recording and reproducing.

(3) With the optical member 7 of the diffraction optical member 1E, it is possible to control the range of the incident angle of an optical beam that enters the polarization hologram 1B within a narrow range. Thus, the range of the available duty ratio can be increased, which results in increasing the allowable value of variation caused during the manufacturing process, and improving the yield ratio.

Additionally, as shown in FIGS. 14A, 14B and 15, by integrating such a diffractive optical element into the optical element unit 11 in which the light source 9 and the photodetector 10 are integrated, it is possible to perform stable signal detection with respect to change over time.

(Embodiment 8)

The optical pickup apparatus described in Embodiment 7 uses the polarization hologram having a high and uniform diffraction efficiency. Thus, the use efficiency of light is high, and it is possible to obtain a highly reliable signal. In addition, when the diffraction efficiency is high, it is possible to decrease the gain of an optical integrated circuit (OPIC) of a signal detection system. Thus, it is possible to contribute to speeding up of a response from the OPIC. Further, it is possible to obtain a signal having a small offset if the diffraction efficiency is not varied in accordance with the incident angle. Hence, it is possible to increase the recording and reproducing speed of the optical disk drive apparatus and to achieve stable servo control.

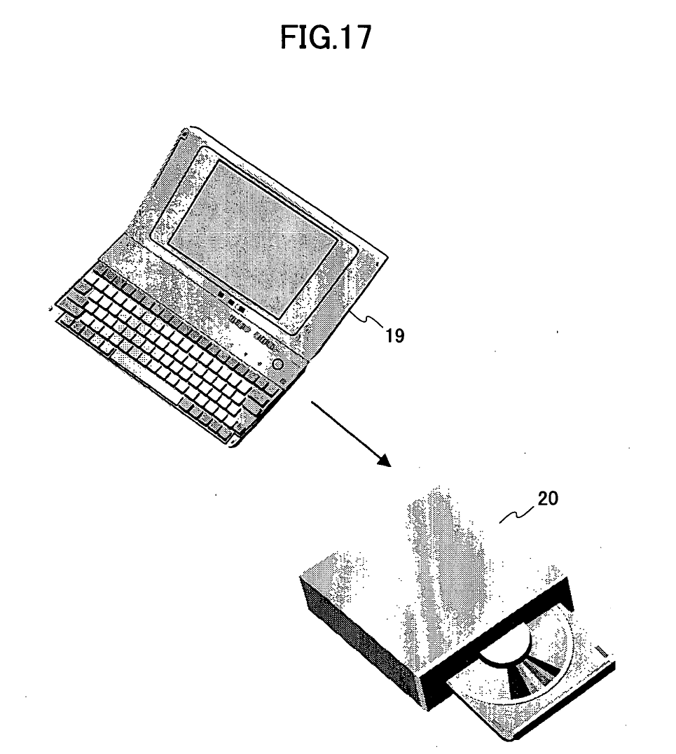

Additionally, in the optical pickup apparatus according to the present invention, the diffractive optical element 1E using the polarization hologram 1B for polarization split is used. Also, the diffractive optical element 1E is integrated with the optical element unit 11 in which the light source 9 and the photodetector (light-receiving element) 10 are arranged. Hence, it is possible to reduce the size and thickness of the optical pickup apparatus. Therefore, it is possible to use the optical pickup apparatus according to the present invention as an optical pickup apparatus of the optical disk drive 20 that is mounted in a notebook personal computer 20 as shown in FIG. 17.

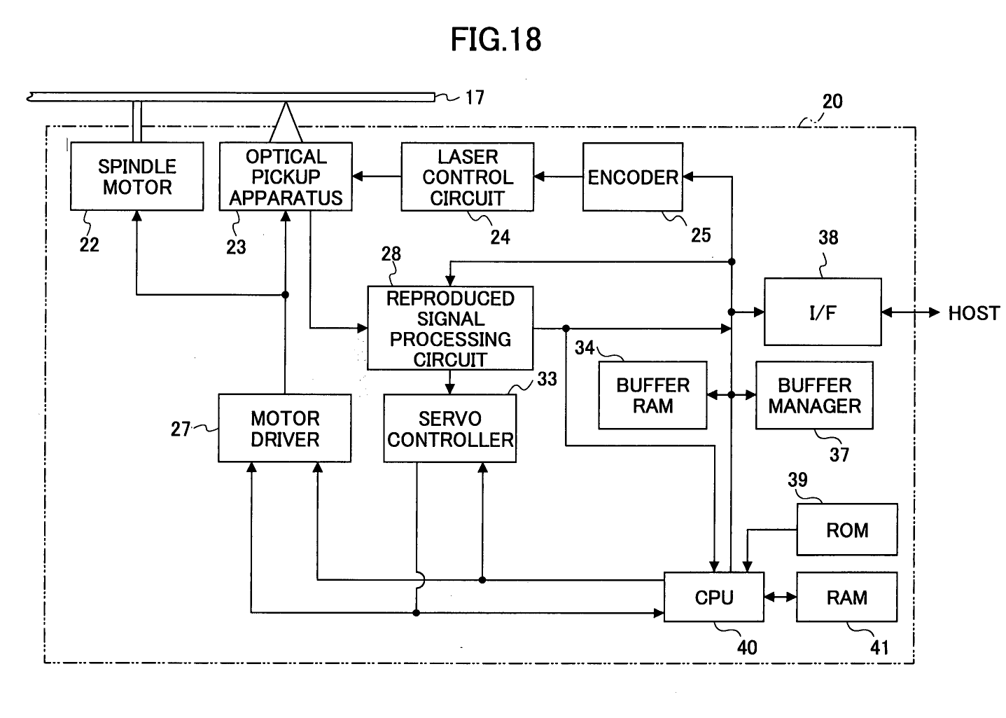

FIG. 18 is a block diagram showing a general configuration of the optical disk drive apparatus 20. The optical disk drive apparatus 20 includes a spindle motor 22 for rotating the optical disk 17 serving as an information recording medium, an optical pickup apparatus 23, a laser control circuit 24, an encoder 25, a motor driver 27, a reproduced signal processing circuit 28, a servo controller 33, a buffer RAM 34, a buffer manager 37, an interface (I/F) 38, a read-only memory (ROM) 39, a central processing unit (CPU) 40, and a random access memory (RAM) 41. It should be noted that arrows in FIG. 18 indicate typical flows of signals and information, and do not indicate all connection relationships among the blocks. In addition, the optical disk 17 may be a compact disk (CD, CD-R, and CD-RW), a digital versatile disk (DVD, DVD-R, and DVD-RW), and the like. It is possible for the optical pickup apparatus 23 to allow interchangeability among the media by providing a plurality of light sources, each having a different wavelength, in the optical pickup apparatus 23.

The optical pickup apparatus 23 is an apparatus for illuminating the recording surface of the optical disk 17 having a spiral or concentric track formed thereon with a laser beam, and performing recording and/or reproducing of information by receiving a reflected light from the storage surface. The optical pickup apparatus 23 has, for example, the configuration as shown in FIG. 13 described in Embodiment 7.

The reproduced signal processing circuit 28 converts a current signal, which is an output signal of the optical pickup apparatus 23, into a voltage signal. Based on the voltage signal, a wobble signal, a RF signal including reproduction information, a servo signal (focus error signal, track error signal) and the like are detected. In the reproduced signal processing circuit 28, address information, a synchronization signal and the like are extracted from the wobble signal. The address information thus extracted is output to the CPU 40, and the synchronization signal is output to the encoder 25. Further, the reproduced signal processing circuit 28 performs an error correction process and the like on the RF signal, and thereafter stores the RF signal in the RAM 24 via the buffer manager 37. In addition, the servo signal is output from the reproduced signal processing circuit 28 to the servo controller 33. The servo controller 33 generates a control signal controlling the optical pickup apparatus 23 based on the servo signal and outputs the control signal to the motor driver 27.

The buffer manager 37 manages inputs and outputs of data with respect to the buffer RAM 34. When the amount of stored data reaches a predetermined value, the buffer manager 37 reports to the CPU 40. The motor driver 27 controls the optical pickup apparatus 23 and the spindle motor 22 based on the control signal from the servo controller 33 and an instruction from the CPU 40. Based on an instruction of the CPU 40, the encoder 25 reads the data stored in the buffer RAM 34 via the buffer manager 37, performs, for example, addition of an error correction code, and creates data to be written on the optical disk 17. Also, the encoder 25 outputs the data to be written to the laser control circuit 24 in synchronization with a synchronization signal from the reproduced signal processing circuit 28. Based on the data to be written supplied from the encoder 25, the laser control circuit 24 controls the laser beam output from the optical pickup apparatus 23.

The interface 38 is an interactive communication interface with a host (a personal computer, for example), and conforms to a standard interface such as ATAPI (AT Attachment Packet Interface) and SCSI (Small Computer System Interface).

The ROM 39 stores a program for control and the like described in code that can be decoded by the CPU 40. The CPU 40 controls the operation of each of the above-mentioned parts in accordance with the programs stored in the ROM 39 and temporarily maintains data and the like necessary for the control in the RAM 41.

The description of one configuration of the optical pickup apparatus is given above. In the present invention, the optical pickup apparatus using the optical element (polarizing optical element, diffractive optical element) described in Embodiments 1 through 6 (the optical pickup apparatus having the configuration shown in FIG. 16, for example) is used as the optical pickup apparatus 23. Hence, light use efficiency is high, a highly reliable signal is obtained, and recording and reproducing speed can be increased.

As mentioned above, in the polarizing optical element according to the present invention, the duty ratio of the grating is limited to the range of 0.4-0.5 (more preferably, approximately 0.45). Hence, it is possible to control the dependency of the diffraction efficiency on the incident angle. As a result, it is possible to achieve a high and uniform diffraction efficiency irrespective of the incident angle of an optical beam. Accordingly, it is possible to achieve a high diffraction efficiency without generating an unbalanced signal.

In addition, in the polarizing optical element according to the present invention, protrusions and recesses are formed on an optical anisotropic material, and at least the recesses are filled with an isotropic material. Thus, it is possible to perform processing with accuracy such that the duty ratio of the grating falls within the range of 0.4-0.5. Hence, it is possible to achieve an equal diffraction efficiency irrespective of the incident angle of an optical beam, and to reduce costs.

In the diffractive optical element according to the present invention, the polarizing optical element of the present invention is sandwiched between two optical members. Thus, the polarizing optical element is covered by the optical members. Hence, it is possible to achieve high planarity and stability with respect to heat and humidity. In addition, since the hologram surface is not directly exposed, it is possible to prevent the polarizing optical element from being damaged or becoming dirty. Further, since the incident angle of an optical beam with respect to the polarizing optical element can be decreased, it is possible to ensure a large allowable value for the dependency on the incident angle. Hence, variation in the diffraction efficiency can be reduced.

In the diffractive optical element according to the present invention, the thicknesses of the two optical members are made different. Hence, without changing the entire thickness of the element, it is possible to make the polarizing optical element distant from the photodetector and to increase the pitch of the grating (grating pitch). Also, it is possible to decrease the Q value and reduce the dependency of the diffraction efficiency on the incident angle. In addition, since the grating pitch of the polarizing optical element can be increased, processing becomes easier.

Additionally, in the diffractive optical element according to the present invention, the refractive index of one of the two optical members is made greater than that of the other. Hence, it is possible to further decrease the incident angle of an optical beam entering the polarizing optical element, and ensure a larger allowable value for the dependency on the incident angle. Accordingly, it is possible to provide a diffractive optical element superior in processability without increasing the costs.

Additionally, in the diffractive optical element according to the present invention, a diffraction grating is formed on one of the two optical members. Hence, it is possible to perform signal detection by illuminating a recording medium with three optical beams, and detect a track signal stably with respect to an optical axis shift. In addition, if a sub-beam enters the polarizing optical element at an angle, the dependency of the diffraction efficiency on the incident angle is controlled by limiting the duty ratio of the grating to the range of 0.4-0.5. Hence, it is possible to achieve a high diffraction efficiency without generating an unbalanced sub-beam signal.

Additionally, in the optical element unit according to the present invention, the unit into which the light source and the photodetector are integrated is integrated with the polarizing optical element or the diffractive optical element. Hence, it is possible to perform stable signal detection with respect to change over time.

Further, the optical pickup apparatus according to the present invention uses the polarizing optical element or the diffractive optical element having an equal diffraction efficiency irrespective of the incident angle of an optical beam. Hence, since an unbalanced signal is not generated, it is possible to perform accurate tracking signal detection. Moreover, high-speed recording becomes possible.

Additionally, the optical disk drive apparatus according to the present invention mounts the above-mentioned optical pickup apparatus. Hence, it is possible to perform stable signal detection and increase the recording and/or reproducing speed.

The present invention is not limited to the specifically disclosed embodiments, and variations and modifications may be made without departing from the scope of the present invention.

The present application is based on Japanese priority application No. 2002-380778 filed on Dec. 27, 2002, the entire contents of which are hereby incorporated by reference.

1. A polarizing optical element used in an optical pickup apparatus,
wherein a diffraction grating (hologram) is formed on said polarizing optical element, and a diffraction efficiency of said diffraction grating varies depending on a polarization direction of an optical beam incident thereon, and
wherein, when a duty ratio of the diffraction grating is defined as a ratio of a width of a protrusion of the diffraction grating to a grating period, the duty ratio of the diffraction grating is within a range of 0.4-0.5.

2. The polarizing optical element as claimed in claim 1, wherein the diffraction grating is manufactured by forming protrusions and recesses on an optical anisotropic material, and filling at least the recesses with an isotropic material.

3. A diffractive optical element used in an optical pickup apparatus, comprising:
a first optical member;
a second optical member; and
a polarizing optical element,
wherein a diffraction grating (hologram) is formed on said polarizing optical element and a diffraction efficiency of said diffraction grating varies depending on a polarization direction of an optical beam incident thereon,
wherein, when a duty ratio of the diffraction grating is defined as a ratio of a width of a protrusion of the diffraction grating to a grating period, the duty ratio of the diffraction grating is within a range of 0.4-0.5, and
wherein the polarizing optical element is sandwiched between said first optical member and said second optical member.

4. The diffractive optical element as claimed in claim 3, wherein the first optical member and the second optical member have different thicknesses.

5. The diffractive optical element as claimed in claim 3, wherein the first optical member and the second optical member have different refractive indexes.

6. The diffractive optical element as claimed in claim 3, wherein a diffraction grating is formed on a surface of one of the first optical member and the second optical member.

7. An optical element unit, comprising:
a unit into which a light source and a photodetector are integrated; and
a diffractive optical element using a polarizing optical element,
wherein a diffraction grating (hologram) is formed on said polarizing optical element, and a diffraction efficiency of said diffraction grating varies depending on a polarization direction of an optical beam incident thereon,
wherein, when a duty ratio of the diffraction grating is defined as a ratio of a width of a protrusion of the diffraction grating to a grating period, the duty ratio of the diffraction grating is within a range of 0.4-0.5, and
wherein said unit is integrated with the diffractive optical element.

8 (Cancelled).

9. An optical pickup apparatus that converges light from a light source to a recording medium by a converging lens so as to perform recording and/or reproducing thereon, said optical pickup apparatus comprising:
an optical system comprising:
a diffractive optical element arranged on a light path so as to diverge a reflected light from the recording medium; and
a photodetector that receives the reflected light,
wherein said diffractive optical element includes a polarizing optical element having a diffraction grating (hologram) formed thereon, and a diffraction efficiency of said diffraction grating varies depending on a polarization direction of an optical beam incident thereon, and, when a duty ratio of the diffraction grating is defined as a ratio of a width of a protrusion of the diffraction grating to a grating period, the duty ratio of the diffraction grating is within a range of 0.4-0.5.

10-22 (Cancelled).

23. An optical disk drive apparatus that performs recording and/or reproducing of information with respect to a recording medium by using an optical pickup apparatus,
said optical pickup apparatus converging light from a light source to the recording medium by a converging lens so as to perform recording and/or reproducing thereon, and said optical pickup apparatus comprising:
an optical system comprising:
a diffractive optical element arranged on a light path so as to diverge a reflected light from the recording medium; and
a photodetector that receives the reflected light, wherein said diffractive optical element includes a polarizing optical element having a diffraction grating (hologram) formed thereon, and a diffraction efficiency of said diffraction grating varies depending on a polarization direction of an optical beam incident thereon, and, when a duty ratio of the diffraction grating is defined as a ratio of a width of a protrusion of the diffraction grating to a grating period, the duty ratio of the diffraction grating is within a range of 0.4-0.5.

24-36 (Cancelled).
